(19) United States
(12) Patent Application Publication
(10) Pub. No.: US 2021/0344122 A1
(43) Pub. Date: Nov. 4, 2021

(54) BASE STATION ANTENNAS HAVING RADIATING ELEMENTS FORMED ON FLEXIBLE SUBSTRATES AND/OR OFFSET CROSS-DIPOLE RADIATING ELEMENTS

(71) Applicant: CommScope Technologies LLC, Hickory, NC (US)

(72) Inventors: Amit Kaistha, Coppell, TX (US); Chengcheng Tang, Murphy, TX (US)

(21) Appl. No.: 17/280,964

(22) PCT Filed: Sep. 11, 2019
(86) PCT No.: PCT/US2019/050552

§ 371 Date: Mar. 29, 2021

Related U.S. Application Data
(60) Provisional application No. 62/753,101, filed on Oct. 31, 2018.

(51) Int. Cl. H01Q 21/24; H01Q 9/16; H01Q 19/10; H01Q 1/24

(52) U.S. Cl. CPC H01Q 21/24; H01Q 1/246; H01Q 19/10; H01Q 9/16

(57) ABSTRACT

A base station antenna includes an array that has a plurality of sub-arrays, each sub-array including at least one radiating element, wherein a first of the sub-arrays includes a first radiating element that is formed in a flexible substrate that is mounted on a rigid support.

### CROSS-REFERENCE TO RELATED APPLICATION

The present application claims priority under 35 U.S.C. § 119 to U.S. Provisional Patent Application Ser. No. 62/753,101, filed Oct. 31, 2018, the entire content of which is incorporated herein by reference.

### BACKGROUND

The present invention generally relates to radio communications and, more particularly, to base station antennas for cellular communications systems.

Cellular communications systems are well known in the art. In a cellular communications system, a geographic area is divided into a series of regions or “cells” that are served by respective base stations. Each base station may include one or more base station antennas that are configured to provide two-way radio frequency (“RF”) communications with subscribers that are within the cell served by the base station. In many cases, each base station is divided into “sectors.” In one common configuration, a hexagonally-shaped cell is divided into three 120° sectors in the azimuth plane, and each sector is served by one or more base station antennas. Typically, the base station antennas are mounted on a tower or other raised structure, with the radiation patterns or “antenna beams” that are generated by the base station antennas directed outwardly to provide coverage to the respective sectors.

Base station antennas typically are implemented as phased array antennas that include a plurality of radiating elements that are arranged in either linear or planar arrays. In the most common design, the radiating elements are arranged in a vertically-extending column as a linear array of radiating elements. The linear array will include between perhaps 5 and 20 radiating elements. Each radiating element forms an individual antenna beam that has a beamwidth in the azimuth plane that corresponds to the angle subtended in the azimuth plane by the sector that the base station antenna is designed to serve (most typically 120°). The antenna beam formed by each radiating element will typically have a beamwidth in the elevation plane that exceeds a desired elevation beamwidth (desired elevation beamwidths are often in the 8-20 degree range). By providing a plurality (e.g., 5-20) of radiating elements that all receive sub-components of the same RF signal, and by providing a phase taper to these sub-components, the elevation beamwidth of the linear array may be narrowed to match a desired elevation beamwidth.

The individual radiating elements may comprise, for example, dipole or patch radiating antenna elements. Most modern base station antennas employ dual polarized radiating elements that include two radiators (e.g., two dipoles) that are configured to form respective antenna beams that have orthogonal polarizations. For example, cross-dipole radiating elements are widely used in base station antennas. A cross-dipole radiating element includes a pair of dipole radiators that are arranged to form an “X” when viewed from the front. Typically one of the radiators extends along an axis that forms an angle of −45° with the horizontal plane defined by the horizon, and the other radiator extends along an axis that forms an angle of +45° with the horizontal plane defined by the horizon. Most cross-dipole radiating elements include two dipole radiators that each have a pair of dipole arms, and the dipole radiators are “center fed” by applying the sub-components of the RF signal to the inner portion of each dipole arm.

### BRIEF DESCRIPTION OF THE DRAWINGS

FIG. 1A is a perspective view of a conventional base station antenna.

FIGS. 1B and 1C are a front view and an enlarged partial perspective view of the conventional base station antenna of FIG. 1A with the radome thereof removed.

FIG. 1D is a perspective view of one of the mid-band feed board assemblies included in the conventional base station antenna of FIGS. 1A-1C.

FIG. 2A is a perspective view of a feed board assembly that includes a pair of cross-dipole radiating elements according to embodiments of the present invention.

FIGS. 2B-2D are a front view, a rear view and a side, view, respectively, of the feed board assembly illustrated in FIG. 2A.

FIGS. 3A and 3B are front and rear views of a flexible substrate used to form the pair of cross-dipole radiating elements illustrated in FIGS. 2A-2D.

FIG. 4 is a perspective view of a feed board assembly that includes three cross-dipole radiating elements according to embodiments of the present invention.

FIG. 5 is a graph illustrating the simulated azimuth pattern of a base station antenna that includes a linear array formed using the feed board assemblies of FIGS. 2A-2D.

FIG. 6 is a perspective view of a feed board assembly that includes two patch radiating elements according to embodiments of the present invention.

FIG. 7 illustrates a portion of a flexible substrate according to further embodiments of the present invention.

### DETAILED DESCRIPTION

The linear arrays of many conventional base station antennas include a plurality of feed board assemblies which together form the linear array. Each feed board assembly includes one or more radiating elements that are mounted on a feed board printed circuit board. First and second coaxial cables terminate into the feed board printed circuit board that feeds sub-components of first and second RF signals to the feed board printed circuit board. The radiating elements extend forwardly from the feed board printed circuit board. If multiple radiating elements are mounted to the feed board printed circuit board, then power dividers are typically provided on the feed board printed circuit board. Each radiating element typically includes a pair of stalk printed circuit boards and a dipole printed circuit board that is mounted on the stalk printed circuit boards. The base of each stalk printed circuit board may be soldered to the feed board printed circuit board, and the dipole printed circuit board is soldered to the distal ends of the stalk printed circuit boards.

Each such conventional feed board assembly may include a large number of parts which must be formed and assembled together, increasing the cost of the base station antenna. Additionally, the numerous soldered connections complicate fabrication and are potential sources for passive intermodulation (PIM), which, if present, may seriously degrade the performance of the base station antenna.

Pursuant to embodiments of the present invention, feed board assemblies are provided that include dual-polarized radiating elements that are formed on flexible substrates such as flexible printed circuit boards or polyethylene terephthalate (PET) substrates with metal patterns formed thereon. In some embodiments, the feed board printed circuit boards, feed stalk printed circuit boards and dipole printed circuit boards that are included in many conventional feed board assemblies may all be implemented on a single flexible printed circuit board instead of as individual components. This may eliminate a number of assembly steps that are required to fabricate conventional antennas. In addition, solder joints that are used to mount the feed stalks to the feed board printed circuit boards and that are used to mount the dipole printed circuit board to the feed stalks may not be necessary in the base station antennas according to embodiments of the present invention. As solder joints can be labor intensive to form and may be potential sources of PIM distortion, eliminating these solder joints may simplify fabrication and improve the performance of the antenna.

The feed board assemblies according to embodiments of the present invention may be used in base station antennas. For example, in some embodiments, base station antennas may be provided that include at least one array of radiating elements. The array of radiating elements may include a plurality of sub-arrays, where each sub-array includes at least one radiating element. Each of the sub-arrays may comprise a feed board assembly according to embodiments of the present invention. Accordingly, a first of the sub-arrays may include a first radiating element that is formed on a flexible substrate that is mounted on a rigid support.

The first radiating element may include first and second dipole radiators that are configured to transmit at orthogonal polarizations. The first and second dipole radiators and first and second feed lines that connect to the respective first and second dipole radiators are formed in the flexible substrate. The flexible substrate may include a first metal pattern that is coupled to ground, a second metal pattern that includes a first signal trace, and a dielectric layer that is interposed between the first and second metal patterns. The first and second dipole radiators may be part of the first metal pattern. An outer conductor of a first coaxial feed cable may be electrically coupled to the first metal pattern, and a center conductor of the first coaxial feed cable may be electrically coupled to the second metal pattern.

In other embodiments, base station antennas are provided that include a reflector and a phased array of radiating elements. The radiating elements are mounted to extend forwardly from the reflector, and each radiating element comprises a dual-polarized radiating element that includes first and second dipole radiators that are formed in a flexible substrate.

Pursuant to further embodiments of the present invention, base station antennas are provided that include a linear array of dual-polarized radiating elements, each dual-polarized radiating element including a first dipole radiator and a second dipole radiator. Opposed ends of each first dipole radiator define a respective first segment and opposed ends of each second dipole radiator define a respective second segment. For each dual-polarized radiating element, the second segment that is perpendicular to the first segment. The first segments do not intersect any of the second segments so that each dual-polarized radiating element is implemented as an offset radiating element that has non-crossing dipole radiators. In some embodiments, centers of the first dipole radiators may be aligned in a first vertical column and centers of the second dipole radiators may be aligned in a second vertical column that is laterally offset from the first column. In some embodiments, the dual-polarized radiating elements may be formed on one or more flexible substrates that may be mounted on one or more rigid support structures.

Pursuant to yet further embodiments of the present invention, base station antennas are provided that include a linear array of dual-polarized radiating elements, each dual-polarized radiating element including a first dipole radiator and a second dipole radiator, a first cable termination and a second cable termination, and a first feed line and a second feed line that are formed in a flexible substrate. The first feed line extends between the first cable termination and the first dipole radiator and the second feed line extends between the second cable termination and the second dipole radiator.

Before describing the radiating elements, feed board assemblies and base station antennas according to embodiments of the present invention, it is helpful to describe a typical conventional base station antenna and the radiating elements and feed board assemblies included in such an antenna.

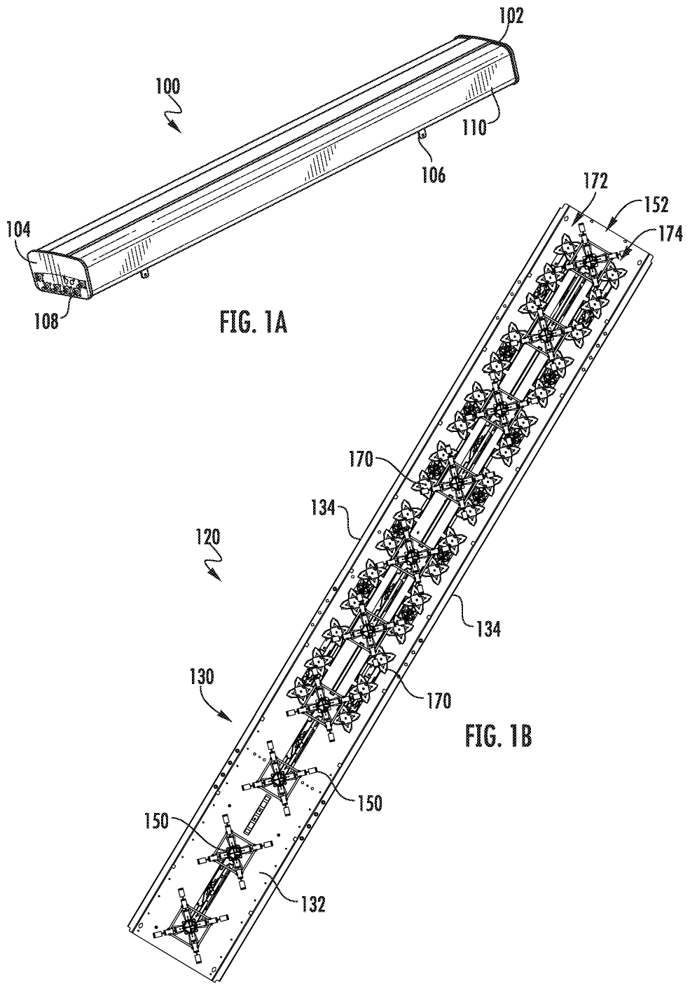

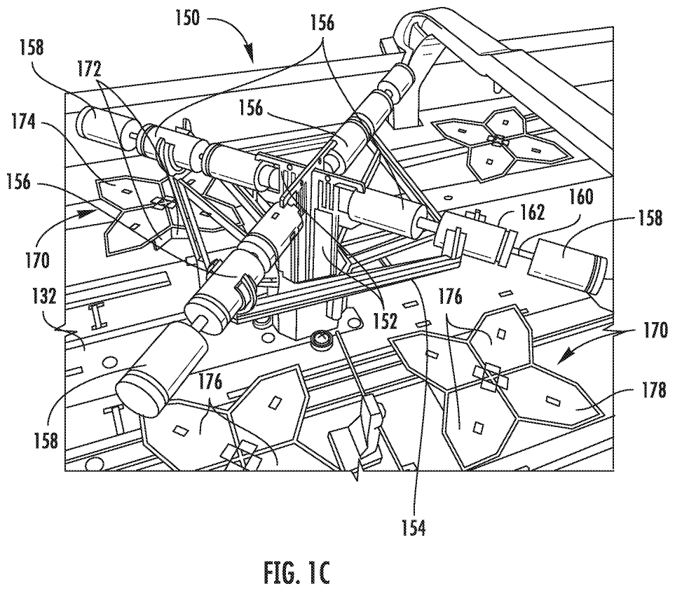

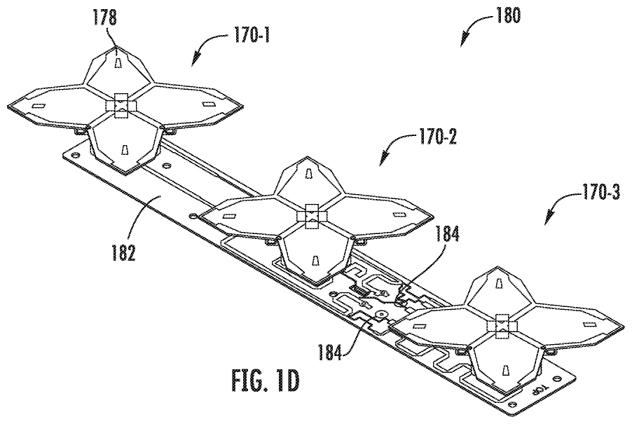

FIGS. 1A-1D illustrate a conventional multi-band base station antenna 100. As will be explained below, the conventional antenna 100 may be modified according to the teachings of the present invention to include radiating elements that are formed in flexible substrates, which may improve performance and/or reduce cost in various base station antenna applications. FIG. 1A is a perspective view of the antenna 100, while FIGS. 1B-1C are a front view and an enlarged partial perspective view, respectively, of the base station antenna 100 with the radome removed. FIG. 1D is a perspective view of one of the mid-band radiating element feed board assemblies included in base station antenna 100. In the description that follows, the antenna 100 and the components thereof are described using terms that assume the antenna 100 is mounted for use on a tower with the longitudinal axis of the antenna 100 extending along a vertical axis and the front surface of the antenna 100 mounted opposite the tower pointing toward the coverage area for the antenna 100. Herein, the vertical direction refers to a direction that is perpendicular to the plane defined by the horizon.

Referring first to FIG. 1A, the base station antenna 100 is an elongated structure and may have a generally rectangular shape. The antenna 100 includes a top end cap 102, a bottom end cap 104 and a radome 110. The radome 110 may comprise a hollow, generally rectangular tube with a bottom opening that is made of fiberglass or another suitable material. The bottom end cap 104 may cover the bottom opening of the radome 110. The top end cap 102 may be part of the radome 110. Mounting brackets 106 may be provided on the back side of the antenna 100 which may be used to mount the antenna 100 onto an antenna mount (not shown) on, for example, an antenna tower. The bottom end cap 104 may include a plurality of connectors 108 mounted therein that receive cables that carry RF signals between base station antenna 100 and one or more associated radios.

FIG. 1B is a front view of the base station antenna 100 with the radome 110 and radome supports removed. The portion of base station antenna 100 depicted in FIG. 1B is referred to herein as the antenna assembly 120. The antenna assembly 120 may be slidably inserted into the radome 110 through the bottom opening thereof. The antenna assembly 120 includes a reflector assembly 130 that has a main reflective surface 132 and rearwardly-extending sidewalls 134. Various components such as, for example, phase shifters, remote electronic tilt (“RET”) units, mechanical linkages, diplexers, and the like (not shown) may be mounted behind the reflector assembly 130.

Referring to FIGS. 1B-1C, a plurality of radiating elements are mounted to extend forwardly from the reflector assembly 130. The radiating elements include low-band radiating elements 150 and mid-band radiating elements 170. The low-band radiating elements 150 are mounted along a first vertical axis to form a linear array 152 of low-band radiating elements 150. The mid-band radiating elements 170 may be divided into two groups that are mounted along respective second and third vertical axes to form a pair of linear arrays 172, 174 of mid-band radiating elements 170. The low-band radiating elements 150 may be configured to transmit and receive signals in a first frequency band. In some embodiments, the first frequency band may be the 555-960 MHz frequency band or a portion thereof. The mid-band radiating elements 170 may be configured to transmit and receive signals in a second frequency band. In some embodiments, the second frequency band may be the 1.695-2.690 GHz frequency range or a portion thereof.

While the antenna 100 includes a linear array 152 of low-band radiating elements 150 and two linear arrays 172, 174 of mid-band radiating elements 170 that are positioned on either side of the linear array 152 of low-band radiating elements 150, it will be appreciated that this is just one typical example of a multi-band base station antenna. Different numbers of linear arrays may be provided and the linear arrays may be positioned differently. Other types of linear arrays (e.g., linear arrays of high-band radiating elements such as radiating elements that transmit and receive signals in the 3.3-4.2 GHz frequency band or a portion thereof) may additionally or alternatively be included in the base station antenna 100. It will likewise be appreciated that the number of radiating elements included in each linear array may be varied, and/or that one or more of the linear arrays can be replaced with two dimensional planar arrays.

FIGS. 1C-1D illustrate the design of the radiating elements 150, 170 in greater detail. As shown in FIG. 1C, each low-band radiating element 150 includes a pair of feed stalk printed circuit boards 152, a dipole support 154 and four dipole arms 158 that form a pair of crossed dipole radiators 156. Each feed stalk printed circuit board 152 may include an RF transmission line that is part of the transmission path between each dipole radiator 156 and respective ports of a radio. Each dipole arm 158 may comprise an elongated center conductor 160 that has a series of coaxial chokes 162 mounted thereon. Each coaxial choke 162 may comprise a hollow metal tube that has an open end and a closed end that is grounded to the center conductor 160. Each dipole arm 158 may be, for example, between ⅜ to ½ of a wavelength in length, where the “wavelength” refers to the wavelength corresponding to the center frequency of the operating frequency band of the low-band radiating elements 150. The dipole arms 158 may be arranged as two pairs of commonly fed collinear dipole arms 158. The dipole arms 158 of the first pair are commonly fed from a first of the feed stalk printed circuit boards 152 to form a first dipole radiator 156 that is configured to transmit and receive RF signals having a +45 degree polarization. The other pair of collinear dipole arms 158 are center fed from the second of the feed stalk printed circuit boards 152 to form a second dipole radiator 156 that is configured to transmit and receive RF signals having a −45 degree polarization. The dipole radiators 156 may be mounted approximately a quarter wavelength in front of the reflective surface 132 by the feed stalk printed circuit boards 152, where the “wavelength” refers to the wavelength corresponding to the center frequency of the operating frequency for the low-band radiating elements 150.

As shown in FIGS. 1C-1D, each mid-band radiating element 170 includes a pair of feed stalk printed circuit boards 172 and a dipole printed circuit board 174 that has four dipole arms 178 formed thereon that form a pair of crossed dipole radiators 176. Each feed stalk printed circuit board 172 may include an RF transmission line that is part of the transmission path between each dipole radiator 176 and respective ports of a radio. Each dipole arm 178 may comprise a generally leaf-shaped conductive region on the dipole printed circuit board 174. The dipole printed circuit board 174 may include slots that receive upwardly-extending tabs that are included on the respective feed stalk printed circuit boards 172 in order to mount the dipole printed circuit board 174 on the feed stalk printed circuit boards 172. Solder joints may be formed at the tab/slot intersections that electrically connect the RF transmission lines on the respective feed stalk printed circuit boards 172 to the respective dipole radiators 176. A first pair of the dipole arms 178 are commonly fed from a first of the feed stalk printed circuit boards 172 to form a first dipole radiator 176 that is configured to transmit and receive RF signals having a +45 degree polarization. The remaining two dipole arms 178 are commonly fed from the second of the feed stalk printed circuit boards 172 to form a second dipole radiator 176 that is configured to transmit and receive RF signals having a −45 degree polarization. Each dipole arm 178 may be, for example, between ⅜ to ½ of a wavelength in length, where the “wavelength” refers to the wavelength corresponding to the center frequency of the operating frequency for the mid-band radiating elements 170. The dipole radiators 176 may be mounted approximately a quarter wavelength in front of the reflective surface 132 by the feed stalks 172, where the “wavelength” refers to the wavelength corresponding to the center frequency of the operating frequency for the mid-band radiating elements 170.

As shown FIG. 1D, the mid-band radiating elements 170 are mounted on a feed hoard printed circuit board 182. The feed board printed circuit board 182 and the three mid-band radiating elements 170 together form a feed board assembly 180. Feed board assemblies such as feed board assembly 180 may also be referred to herein as “sub-arrays” as a plurality of these feed board assemblies are typically used to form a linear array or a planar array of radiating elements. The feed board printed circuit board 182 may include a pair of terminations 184 which receive respective first and second coaxial cables (not shown). The first coaxial cable may pass a sub-component of a first RF signal between the −45° dipole radiators and a radio (not shown), and the second coaxial cable may pass a sub-component of a second RF signal between the +45° dipole radiators and the radio. The feed board printed circuit board 182 may include power dividers that further sub-divide the respective sub-components of the first and second RF signals so that a portion of each sub-component is passed to each of the three radiating elements 170 for transmission. The feed stalks 172 of each mid-band radiating element 170 may be inserted into respective openings in the feed board printed circuit board 182 and soldered in place to physically mount the mid-band radiating elements 170 on the feed board printed circuit board 182 and to electrically connect RF transmission lines on the feed board printed circuit board to respective RF transmission lines on the feed stalks 172 to provide appropriate RF transmission paths between the dipole radiators 176 and the radio. While FIG. 1D illustrates a feed board assembly that includes three mid-band radiating elements 170, it will be appreciated that feed board assemblies may have other numbers of radiating elements. For example, FIG. 1B shows that the mid-band linear arrays 172, 174 each include feed board assemblies 180 that have three radiating elements 170, as well as other feed board assemblies that only include two radiating elements 170.

Typically, the feed board assembly 180 may be somewhat complicated to manufacture and assemble. Each mid-band radiating element 170 includes two feed stalk printed circuit boards 172 and a dipole printed circuit board 174. Thus, the feed board assembly 180 includes a total of ten printed circuit boards, counting the feed board printed circuit board 182. Each printed circuit board has slots cut therein, and the printed circuit boards are assembled together and soldered in place. Each solder joint is tested for PIM distortion, and reworked if PIM distortion is present. Thus, the manufacturing process for each feed board assembly may be fairly involved.

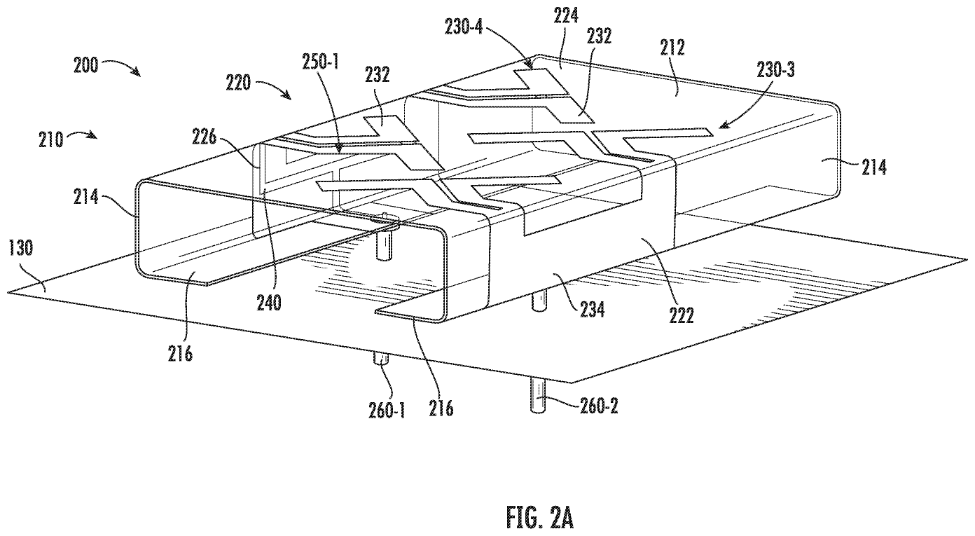

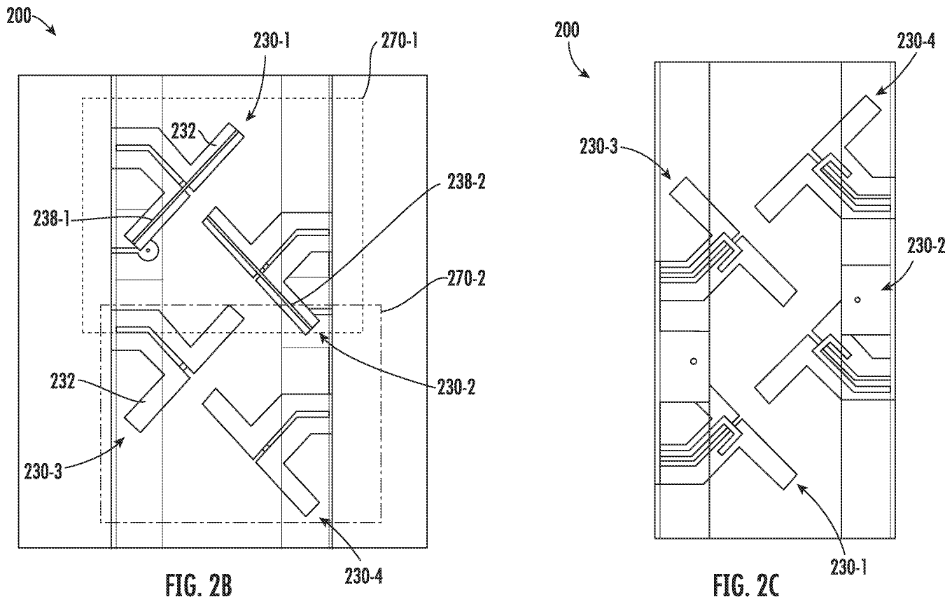

Embodiments of the present invention will now be described in further detail with reference to FIGS. 2A-7.

As discussed above, pursuant to embodiments of the present invention, radiating elements are provided that are formed on a flexible substrate that may be simpler to manufacture than conventional radiating elements. The present invention also encompasses feed board assemblies that include such radiating elements, as well as base station antennas that include such feed board assemblies.

FIGS. 2A-2D illustrate a feed board assembly 200 according to embodiments of the present invention that includes two radiating elements. In particular, FIGS. 2A-2D are a perspective view, a front view, a rear view and a side view of the feed board assembly 200. The feed board assembly 200 may be used in place of the feed board assemblies 180 included in base station antenna 100. While the feed board assembly 200 includes two dual-polarized radiating elements, it will be appreciated that the feed board assembly may be readily modified to include more or fewer dual-polarized radiating elements.

Referring to FIGS. 2A-2D, the feed board assembly 200 includes a rigid support 210 that has a flexible substrate 220 mounted thereon. The rigid support 210 may comprise any structure that is used to mount the flexible substrate 220 in place in a desired position within a base station antenna. In the depicted embodiment, the rigid support 210 includes a planar front surface 212, opposed sidewalls 214, and rear lips 216. As can best be seen in FIG. 2A, the rigid support 210 may have a generally C-shaped cross-section in some embodiments. The rigid support 210 may be mounted to extend forwardly from the reflector 130 of a base station antenna. Plastic rivets or other fasteners (not shown) may extend through apertures (not shown) in the lips 216 and corresponding apertures (not shown) in the reflector 130 in order to mount the rigid support 210 to extend forwardly from the reflector 130.

The flexible substrate 220 may be mounted on the rigid support 210. As shown in FIGS. 2A-2D, portions of the flexible substrate 220 may extend over the front surface 212 and the sidewalls 214 of the rigid support 210. The flexible substrate 210 may also extend onto the rear surfaces of the lips 216 in some embodiments. The flexible substrate 220 may be fixedly mounted to the rigid support 210 in some embodiments. For example, adhesives, clips, fasteners or the like may be used to fixedly mount the flexible substrate 220 to the rigid support 210.

The flexible substrate 220 may comprise, for example, a flexible printed circuit board or a PET substrate with metallized patterns thereon. The flexible substrate 220 may include at least three layers, including a first metal layer 222, a second metal layer 226 and a dielectric layer 224 that is interposed between the first and second metal layers 222, 224. The flexible substrate 220 may replace the feed board printed circuit board 182, the feed stalk printed circuit boards 172, and the dipole printed circuit boards 174 that are included in the feed board assembly 180 of FIG. 1D. In particular, dipole radiators 230-1 through 230-4 are formed in the flexible substrate 220 as metal patterns included in the first metal pattern 222. As shown in FIGS. 2A-2D, each dipole radiator 230 includes a pair of collinear dipole arms 232. Dipole radiators 230-1 and 230-3 are oriented to transmit and receive RF energy at a +45° polarization, and dipole radiators 230-2 and 230-4 are oriented to transmit and receive RF energy at a −45° polarization. Herein, when multiple instances of a structure are provided, these structures may be referred to individually by their full reference numeral (e.g., dipole radiator 230-2) and collectively by the first (common) part of their reference numerals (e.g., the dipole radiators 230).

Dipole radiators 230-1 and 230-2 form a first radiating element 270-1 and dipole radiators 230-3 and 230-4 form a second dual-polarized radiating element 270-2. The opposed ends of dipole radiator 230-1 define a first segment 238-1 that extends at an angle of +45° with respect to the horizon. The opposed ends of dipole radiator 230-2 define a second segment 238-2 that extends at an angle of −45° with respect to the horizon. The second segment 238-2 defines a first axis that intersects the first segment 238-1 at an angle of 90°. The first axis defined by the second segment 238-2 may also bisect the corresponding first segment 238-1 of the radiating element 270 (i.e., the first axis defined by the second dipole radiator 230-2 intersects a center of the first dipole radiator 230-1). As shown in FIGS. 1B-1D, the dipole radiators 176 of conventional slant −45°/+45° dipole radiating elements 170 intersect so that the centers of the dipole radiator 176 are co-existent. In contrast, the first and second segments 238-1, 238-2, and hence the first and second dipole radiators 230-1, 230-2 of each radiating element 270, do not intersect.

Radiating element 270-1 is positioned above radiating element 270-2 when the feed board assembly 200 is mounted for use in a base station antenna. As can best be seen in FIGS. 2B and 2C, +45° dipole radiators 230-1 and 230-3 are aligned along a first vertical axis V1 and −45° dipole radiators 230-2 and 230-4 are aligned along a second vertical axis V2.

Each dipole radiator 230 may, for example, comprise two dipole arms 232 that are each between ⅜ to ½ of a wavelength in length, where the “wavelength” refers to the wavelength in the middle of the operating frequency range of the mid-band radiating elements 270. The dipole radiators 230 may be mounted approximately ¼ of a wavelength forwardly from the reflector 130.

In addition to the dipole radiators 230, the first metal pattern 222 further includes metallized regions 234 that serve as the ground plane for microstrip transmission lines (discussed below). The metallized regions 234 may extend along the portions of the flexible substrate 220 that are on the lips 216, sidewalls 214 and front surface 212 of the rigid support 210. The metallized regions 234 may directly connect to the dipole arms 232 of the dipole radiators 230. The second metal pattern 226 may comprise metal traces 240 that extend opposite the ground plane formed by the metallized regions 234 of the first metal pattern 222. The metal traces 240, the ground plane formed in metallized regions 234 and the dielectric substrate 224 separating the first and second metal layers 222, 226 may form a pair of microstrip transmission lines 250-1, 250-2. Dielectric pads (not shown) may be disposed between the lips 216 and the reflector 130 in order to eliminate metal-to-metal contact between the reflector 130 and portions of the first metal pattern 222 of the flexible substrate 220.

As shown in FIGS. 2A and 2D, first and second coaxial cables 260-1, 260-2 may be connected to the flexible substrate 220. The inner conductor of the first coaxial cable 260-1 may be soldered or otherwise electrically connected to a metal trace 240 of the first RF transmission line 250-1, and the inner conductor of the second coaxial cable 260-2 may be soldered or otherwise electrically connected to a metal trace 240 of the second RF transmission line 250-2. The outer conductors of the first and second coaxial cables 260-1, 260-2 may be soldered or otherwise electrically connected to the metallized patterns 234.

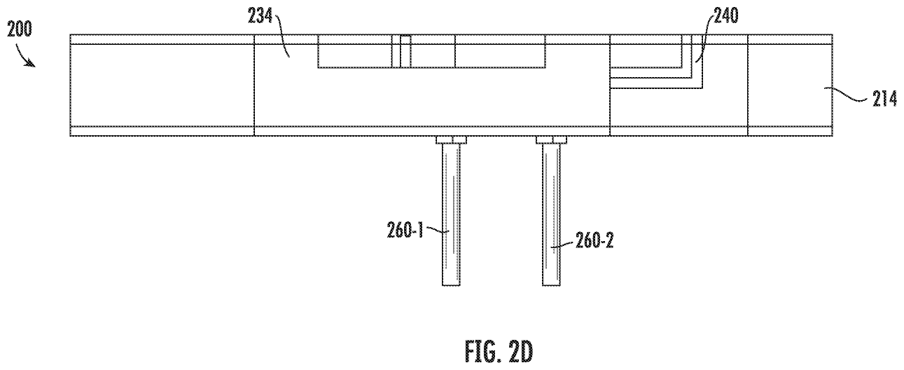

FIGS. 3A and 3B are front and rear view of the flexible substrate 220 spread out as a planar sheet. As shown in FIG. 3A, the first metal pattern 222 comprises the dipole arms 232 and the metallized patterns 234. A pair of apertures 236 may be provided in the metallized patterns 234 so that the center conductors of the first and second coaxial cables 260-1, 260-2 may extend through the respective metallized patterns 234 without making electrical connection thereto. As shown in FIG. 3B, the second metal pattern 226 includes the first and second metal traces 240-1, 240-2. An aperture 242 is provided at a first end of each metal trace 240 that receives the center conductor of a respective one of the coaxial cables 260. The center conductors may be soldered to the respective metal traces 240 at the apertures 242. The metal traces 240 define RF transmission lines 250-1, 250-2. Each RF transmission line 250 includes a first transmission line segment 252 and a pair of second RF transmission line segments 254. A power divider 244 is provided along each metal trace 240 that sub-divides each RF transmission line 250 into the first and second RF transmission line segments 252, 254. Each first RF transmission line segment 252 extends between one of the apertures 242 and a respective one of the power dividers 244. Each RF transmission line segment 254 ends in a hook balun 256. The hook baluns 256 feed respective RF signals to both dipole arms 232 of each respective dipole radiator 230. FIG. 2C illustrates how the hook baluns 256 overlap the dipole arms 232 to allow RF signals to pass between the dipole arms 232 and the RF transmission line segments 254.

An RF signal that is carried on coaxial cable 260-1 will pass to the RF transmission line 252-1. At divider 244-1, the RF signal is divided into two sub-components that are passed to the RF transmission lines 254-1, 254-2. These sub-components traverse RF transmission lines 254-1, 254-2 and at the respective hook baluns 256 the sub-components couple to both dipole arms 232 of the respective dipole radiators 230-1 and 230-3, which may radiate the sub-components of the RF signal into free space.

As discussed above, the feed board assemblies 200 may be used to form a linear array (or a planar array) of radiating elements of a base station antenna. The feed board assemblies 200 may, in some embodiments, comprise a simple two piece structure that includes a rigid support 210 and a flexible substrate 220 that may replace the numerous elements included in conventional feed board assemblies (e.g., a feed board printed circuit board, multiple feed stalk printed circuit boards, and multiple dipole printed circuit boards). The number of feed assemblies 200 that are included in a given linear array may be determined based on, for example, a desired elevation beamwidth for the antenna beam formed by the linear array.

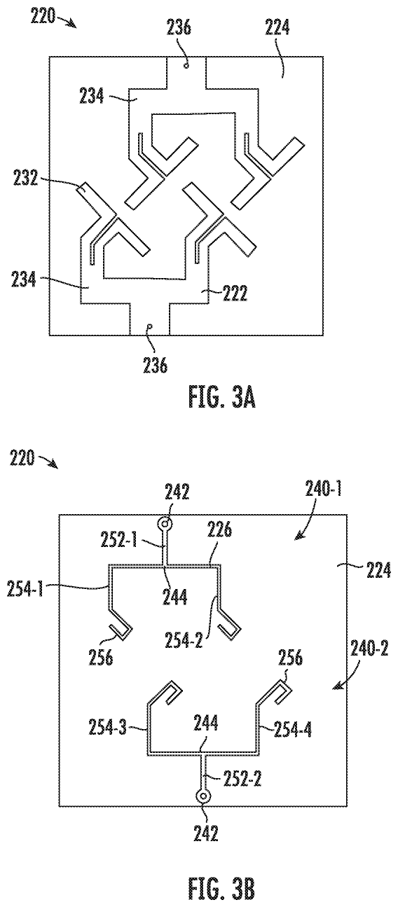

As noted above, any number of radiating elements 270 may be formed on the flexible substrate. For example, FIG. 4 is a perspective view of a feed board assembly 200′ that includes three radiating elements 270. The feed board assembly 200′ may be identical to feed board assembly 200 except that feed board assembly includes a third radiating element 270-3, a three way power dividers 244′, and three RF transmission lines 254 (instead of two) that extend between the power dividers 244′ and the respective radiating elements 270-1 through 270-3. A larger rigid support 210′ may be used to mount the flexible substrate 220′.

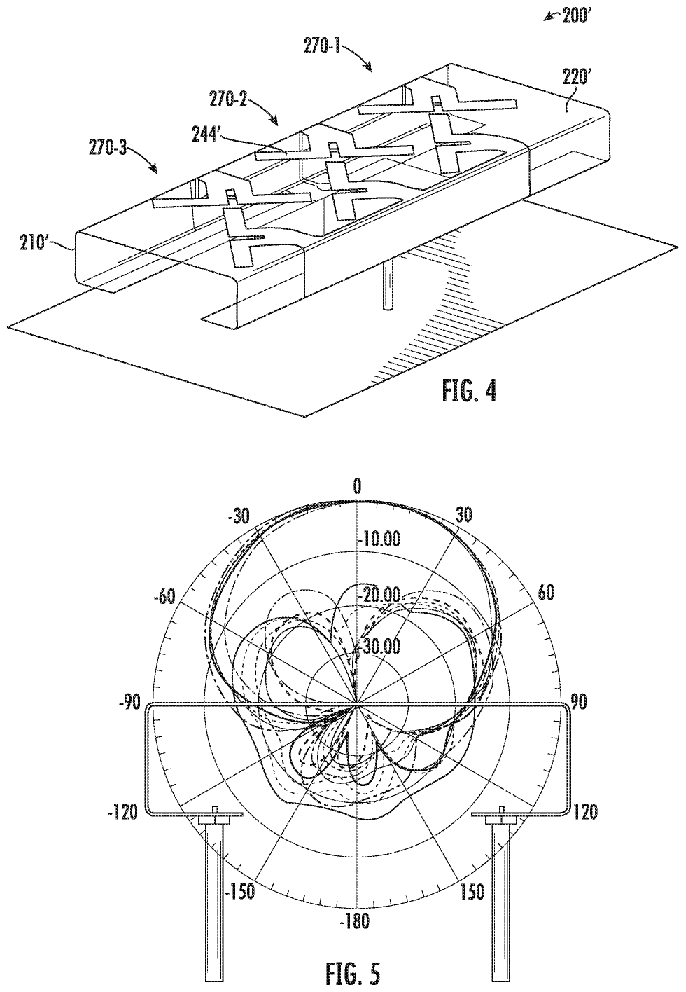

FIG. 5 is a simulated azimuth pattern of an antenna beam formed by a linear array of radiating elements that includes several of the feed board assemblies 200 of FIGS. 2A-2D. As shown in FIG. 5, the antenna beam has a good shape for a sector antenna. The lines in the interior of the main lobe illustrate the cross-polarization performance of the antenna beam.

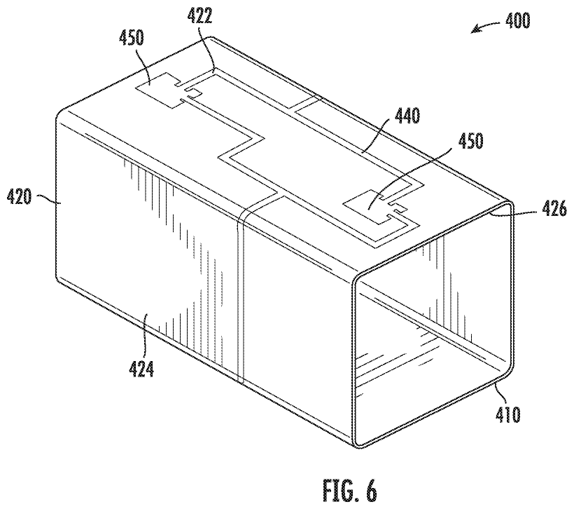

FIG. 6 is a perspective view of a feed board assembly 400 that includes two patch radiating elements according to embodiments of the present invention. As shown in FIG. 6, the feed board assembly 400 includes a rigid support 410 that has a flexible substrate 420 mounted thereon. The rigid support 410 is used to mount the flexible substrate 420 in place in a desired position within an antenna. In the depicted embodiment, the rigid support 410 has the shape of a rectangular tube, although other shapes may be used. The rigid support 410 may be mounted to extend forwardly from the reflector 130 of the antenna.

The flexible substrate 420 may comprise, for example, a flexible printed circuit board. The flexible substrate 410 may include at least three layers, including a first metal layer 422, a second metal layer 426 and a dielectric layer 424 that is interposed between the first and second metal layers 422, 424. The first metal layer 422 may include a ground plane. The second metal layer 426 may include feed lines 440 and dual-polarized patch radiating elements 450. While not shown in FIG. 6, a pair of coaxial cable may terminate into the flexible substrate 420 that pass RF signals to and from the flexible substrate 420. These coaxial cables may terminate into flexible substrate 420 in the exact same manner, described above, that coaxial cables 260 terminate into flexible substrate 220.

It will be appreciated that many changes may be made to the feed board assemblies 200 or 200′ without departing from the scope of the present invention. For example, the dipole radiators 230 in the depicted embodiments are directly fed by the RF transmission lines 254. In other embodiments, RF signals may be capacitively coupled between the RF transmission lines 254 and the dipole arms 232. As another example, it will be appreciated that the physical locations of the dipole radiators 230 may be varied from what is shown in the drawings. For example, the dipole radiators 230 having the same polarization (e.g., the +45° dipole radiators 230) need not be aligned along a vertical axis and/or the segments 238 defined by each −45° dipole radiator 230 and need not define an axis that bisects a corresponding +45° dipole radiator 230.

It will also be appreciated that a wide variety of flexible substrates may be used. Additionally, the coaxial cables may connect to the feed board assemblies at different locations than shown. It will also be appreciated that a wide variety of rigid support structures may be used, including rigid support structures having different shapes and/or rigid support structures formed of different materials. In some embodiments, the material used to form at least portions of the rigid support structure may be selected to improve the electrical transmission properties of the RF transmission lines formed on the flexible substrate.

As another example, different types of power dividers may be used including, for example, Wilkinson power dividers. Moreover, while the description above focuses on the case where mid-band radiating elements are implemented in the feed board assemblies, it will be appreciated that the same techniques may be used to implement low-band or high-band radiating elements simply by appropriately scaling the size of the dipole radiators and the distance that the dipole radiators are mounted forwardly of the reflector. It will be appreciated also that the dipole radiator designs may be changed as appropriate for different frequency bands.

It will also be appreciated that inductors and/or capacitors may be included along the RF transmission lines 254 for purposes of impedance matching the RF transmission lines 254 to the dipole radiators 230. The inductors may be implemented, for example, as meandering transmission line segments and the capacitors may be implemented as plate capacitors that are formed on the first and second metal patterns of the flexible substrate.

While the dipole radiators are implemented as solid dipole arms in the above described examples, embodiments of the present invention are not limited thereto. For example, when the feed board assemblies according to embodiments of the present invention are used to implement low-band radiating elements, it may be desirable to implement each dipole arm as a series of widened conductive segments that are connected by narrow high inductance meandering traces. This may facilitate rendering the low-band radiating elements relatively transparent to closely-located mid-band or high-band radiating elements.

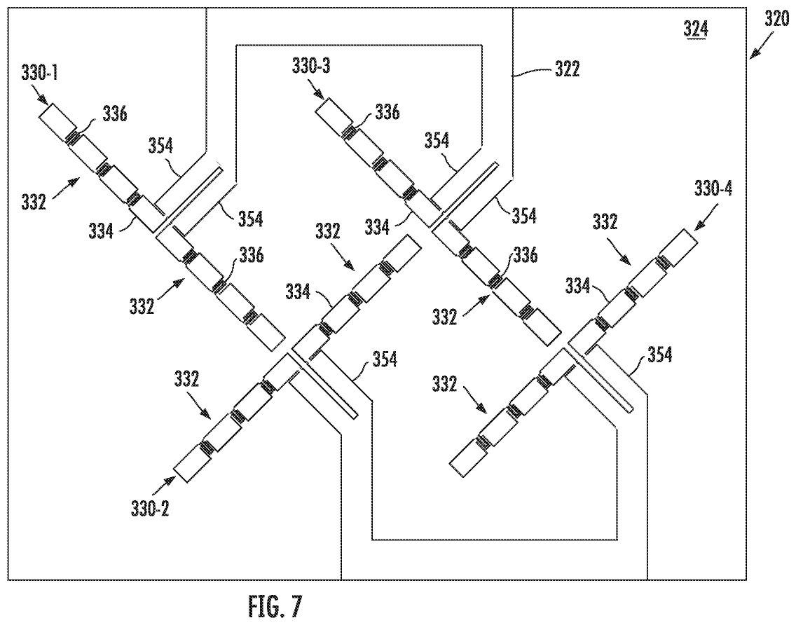

FIG. 7 illustrates a portion of a flexible substrate 320 according to further embodiments of the present invention that includes such dipole radiators 330. In FIG. 7, only the first metal pattern 322 that includes the dipole arms 332 that form the dipole radiators 330 and the dielectric substrate 324 are shown in order to simplify the drawing (i.e., FIG. 7 corresponds to FIG. 3A). As can be seen, the flexible substrate 320 may be essentially identical to the flexible substrate 220 discussed above, except that the dipole arms 232 of flexible substrate 220 are replaced with the dipole arms 332. Each dipole arm 332 includes a plurality of widened segments 334 that are electrically connected to each other by meandered narrow trace segments 336. The meandered narrow trace segments 336 may act like a filter blocking higher band currents from flowing along the dipole arms 332. This may help make the dipole arms 330 transparent to RF energy in the frequency bands of other radiating elements included in a base station antenna.

The radiating elements, feedboard assemblies and base station antennas according to embodiments of the present invention may have various advantages as compared to conventional radiating elements, feedboard assemblies and base station antennas. For example, the radiating elements, feedboard assemblies and base station antennas according to embodiments of the present invention may significantly reduce the overall number of components included in a base station antenna, reducing assembly time and the overall cost of the antenna. Additionally, the radiating elements, feedboard assemblies and base station antennas disclosed herein may significantly reduce the number of soldering operations required to construct the antenna, which again reduces assembly time and costs, reduces the amount of PIM distortion testing necessary, and which may result in an improvement in the PIM distortion performance of the antenna. The radiating elements, feedboard assemblies and base station antennas according to embodiments of the present invention may also exhibit improved reliability.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
an array that includes a plurality of sub-arrays, each sub-array including at least one radiating element, wherein a first of the sub-arrays includes a first radiating element that is formed in a flexible substrate that is mounted on a rigid support.

2. The base station antenna of claim 1, wherein the first radiating element includes first and second dipole radiators that are configured to transmit at orthogonal polarizations.

3. The base station antenna of claim 2, wherein first and second dipole radiators and first and second feed lines for the respective first and second dipole radiators are formed in the flexible substrate.

4. The base station antenna of claim 1, wherein the flexible substrate includes a first metal pattern that is coupled to ground, a second metal pattern that includes a first signal trace, and a dielectric layer that is interposed between the first and second metal patterns.

5. The base station antenna of claim 4, wherein the first and second dipole radiators are part of the first metal pattern.

6. The base station antenna of claim 4, wherein an outer conductor of a first coaxial feed cable is electrically coupled to the first metal pattern, and a center conductor of the first coaxial feed cable is coupled to the second metal pattern.

7. The base station antenna of claim 2, wherein opposed ends of the first dipole radiator define a first segment and opposed ends of the second dipole radiator define a second segment that is perpendicular to the first segment and does not intersect the first segment, and optionally wherein a longitudinal axis of the first dipole radiator intersects a center of the second dipole radiator.

8. (canceled)

9. The base station antenna of claim 1, further comprising a reflector that is mounted behind the array of radiating elements, wherein the rigid support includes a front surface that is parallel to the reflector, a sidewall, and a lip that that is parallel to the reflector.

10. The base station antenna of claim 9, wherein a dielectric spacer is interposed between the lip and the reflector.

11. The base station antenna of claim 1, wherein the first of the sub-arrays further includes a second radiating element that is formed in the flexible substrate, the second radiating element including third and fourth dipole radiators that are configured to transmit at orthogonal polarizations.

12. The base station antenna of claim 11, wherein centers of the first and third dipole radiators are aligned along a first vertical axis and centers of the second and fourth dipole radiators are aligned along a second vertical column that is laterally offset from the first column when the base station antenna is mounted for use.

13. A base station antenna, comprising:
a reflector; and
an array of radiating elements mounted to extend forwardly from the reflector, the array including a first dual-polarized radiating element that includes first and second dipole radiators that are formed in a flexible substrate.

14. The base station antenna of claim 13, wherein first and second feed lines that are coupled to the respective first and second dipole radiators are also formed in the flexible substrate.

15. The base station antenna of claim 13, wherein the flexible substrate includes a first metal pattern that is coupled to ground, a second metal pattern that includes a first signal trace, and a dielectric layer that is interposed between the first and second metal patterns.

16. The base station antenna of claim 15, wherein the first and second dipole radiators are part of the first metal pattern.

17. The base station antenna of claim 15, wherein an outer conductor of a first coaxial feed cable is electrically coupled to the first metal pattern, and a center conductor of the first coaxial feed cable is coupled to the second metal pattern.

18. The base station antenna of claim 13, wherein opposed ends of the first dipole radiator define a first segment and opposed ends of the second first dipole radiator define a second segment that is perpendicular to the first segment and does not intersect the first segment.

19. The base station antenna of claim 13, further comprising a reflector and a rigid support, wherein the rigid support includes a front surface that is parallel to the reflector, a sidewall, and a lip that that is parallel to the reflector, and wherein the flexible substrate is mounted on the rigid support.

20. A base station antenna, comprising:
an array of dual-polarized radiating elements, each dual-polarized radiating element including a first dipole radiator and a second dipole radiator,
wherein opposed ends of each first dipole radiator define a respective first segment and opposed ends of each second dipole radiator define a second segment that is perpendicular to the respective first segment,
wherein the first segments do not intersect any of the second segments.

21. The base station antenna of claim 20, wherein centers of the first dipole radiators are aligned in a first vertical column and centers of the second dipole radiators are aligned in a second vertical column that is laterally offset from the first column.

22. The base station antenna of claim 20, wherein each first segment defines a respective axis that bisects a respective one of the second segments, wherein the dual-polarized radiating elements are formed on one or more flexible substrates wherein the one or more flexible substrates are mounted on one or more rigid supports, and wherein first and second dipole radiators of a first of the dual-polarized radiating elements and first and second feed lines for the first and second dipole radiators are formed in a flexible substrate of the one or more flexible substrates.

23-25. (canceled)

26. The base station antenna of claim 22, wherein the flexible substrate includes a first metal pattern that is coupled to ground, a second metal pattern that includes a first signal trace that is coupled to the first dipole radiator and a second signal trace that is coupled to the second dipole radiator, and a dielectric layer that is interposed between the first and second metal patterns, wherein the first and second dipole radiators are part of the first metal pattern, and wherein an outer conductor of a first coaxial feed cable is electrically coupled to the first metal pattern, and a center conductor of the first coaxial feed cable is coupled to the second metal pattern.

27-28. (canceled)

29. The base station antenna of claim 20, further comprising a reflector that is mounted behind the array of dual-polarized radiating elements, wherein a first of the dual-polarized radiating elements is formed on a flexible substrate that is mounted on a rigid support as one of the one or more flexible substrates, wherein the rigid support includes a front surface that is parallel to the reflector, a sidewall, and a lip that is parallel to the reflector.

30. The base station antenna of claim 29, wherein a dielectric spacer is interposed between the lip and the reflector.

31-35. (canceled)
